(19) United States
(12) Patent Application Publication
(10) Pub. No.: US 2007/0133679 A1
(43) Pub. Date: Jun. 14, 2007

(54) Encoder, method for adjusting decoding calculation, and computer program product therefor

(76) Inventors: Chiu-Nan Yang, Taipei (TW); Yu-Chia Kang, Chiayi City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/356,403

(22) Filed: Feb. 16, 2006

(30) Foreign Application Priority Data
Dec. 8, 2005 (TW) 094143409

(51) Int. Cl. H04N 11/04; H04B 1/66

(52) U.S. Cl. 375/240.07; 375/240.27

(57) ABSTRACT

An encoder, a method for adjusting decoding calculation, and computer program product therefor are provided. The encoder, comprising a parameter generator, an adder and a complexity computation unit, adjusts decoding calculation according to a first encoding parameter which is generated based on a video frame. The method and the computer program product therefor operate: the parameter generator to generate an image quality parameter; the adder to add the first encoding parameter and the image quality parameter to generate a second encoding parameter; the complexity computation unit to perform a complexity computation according to the second encoding parameter and to generate a third encoding parameter and an updating parameter; the parameter generator to update the image quality parameter according to the updating parameter; and the encoder to encode the video frame based on the third encoding parameter.

### CROSS-REFERENCES TO RELATED APPLICATIONS

This application claims priority to Taiwan Patent Application No. 094143409 filed on Dec. 8, 2005.

### STATEMENT REGARDING FEDERALLY SPONSORED RESEARCH OR DEVELOPMENT

Not applicable

### BACKGROUND OF THE INVENTION

1. Field of the Invention

The present invention relates to an encoder and a method for adjusting decoding calculation and a computer program product therefor; specifically to an encoder and a method for adjusting decoding calculation according to a decoding complexity and computer program product therefor.

2. Descriptions of the Related Art

In recent years, transmission capacity of digital communication mediums including cables, satellites and internet grows rapidly. Although the transmission capacity continues increasing, it is still too small for transmitting uncompressed high quality video frames. Under the strong requirement of multiple channels, mobile videos, high quality videos and high definition videos, the current improvement of capacity growth for digital communication mediums is too far behind to meet the requirement.

In addition to continuously breaking through transmission capacity, researching a more efficient video compression scheme is an alternative solution. The earliest video compression standard was developed in 1980 era. With the progress in recent years, video compression standards can provide good compression image qualities and high compression ratios, such as MPEG2 video compression standard, MPEG4 video compression standard, H.264 video compression standard, and motion-compensation based video compression standard. These video compression standards use a block mode and a motion vector as encoding parameters.

FIG. 1 is an internal circuit block diagram of an encoder of the prior art. With reference to FIG. 1, the operation principle of the encoder is described as follows. A video frame 100 is inputted to the encoder. A composed video frame 102 is generated by adding the video frame 100 and a reference video frame 122 (described later) by an adder 101. The composed video frame 102 is inputted to a transformation unit 103. The transformation unit 103 transforms the composed video frame 102 into a video frame transformation signal 104 with a discrete cosine transform (DCT). A video frame quantization signal 106 is generated by removing the high frequency components of the video frame transformation signal 104 by a quantization unit 105 since human eyes are not sensitive to such high frequency components. After the video frame quantization signal 106 is encoded according to a lookup table by an entropy encoding unit 107, a video frame encoding signal 108 is generated. A quantization coefficient 110 is generated after an entropy decoding unit 109 decodes the video frame encoding signal 108. The quantization coefficient 110 is inversely quantized by an inverse quantization unit 111 to generate a transformation coefficient 112. The transformation coefficient 112 is inversely transformed by an inverse transformation unit 113 to generate an estimation video frame error signal 114. After an adder 115 adds the estimation video frame error signal 114 and the reference video frame 122, a decoded video frame 116 is generated. The decoded video frame 116 is stored into a video frame buffer 117. While a next video frame 100 is inputted, the video frame buffer 117 simultaneously outputs a decoded video frame 118, i.e., the previous decoded video frame 116 to a motion compensation unit 119. The video frame 100 is also inputted to a motion estimation and mode decision unit 121 to be calculated with the decoded video frame 118 in order to generate an encoding parameter 120. The encoding parameter 120 and the decoded video frame 118 are calculated by the motion compensation unit 119 to output the aforementioned reference video frame 122. Meanwhile, the encoding parameter 120 is encoded by an entropy encoding unit 123 according to a lookup table to generate an encoding signal 124. The encoding signal 124 and the video frame encoding signal 108 are calculated by a bit stream combination unit 125 to generate an encoded video bit stream 126. The encoded video bit stream 126 is the video compression data encoded by the encoder.

For the aforementioned encoder, the most important factor that affects the image quality and the compression ratio is the encoding parameter 120. Taking the H.264 video compression standard as an example, the encoding parameter 120 comprises a motion vector and a block mode factor. The motion vector is generated according to the following equation:

$$\begin{matrix}{V}^{*} ( B , M ) = {arg min}_{V ∈ sup \{ V \}} {J}_{MODE}^{R , D} ( V \vert B , M ) \\ = {arg min}_{V ∈ sup \{ V \}} \{ {D}_{DFD} ( V \vert B , M ) + {λ}_{MOTION} {R}_{MOTION} ( V \vert B , M ) \}\end{matrix}$$

wherein the V* is the motion vector; the brackets “{ }” represent options of the motion vector, which is calculated according to searching pixel ranges, referenced video frames and estimated directions; the B is a macroblock parameter; the M is a macroblock coding mode allocation parameter; the D_{DFD} is the difference between a current macroblock and a rebuilt macroblock after motion compensation, which represents quality; the λ_{MOTION} is a Lagrange multiplier for a bit rate and the image quality; the R_{MOTION} represents an estimated value of the bit rate; and the J_{MODE}^{R,D}(M) is a total cost function of rate-distortion. The block mode is generated according to the following equation:

$$\begin{matrix}{M}^{*} ( MB , QP ) = {arg min}_{M ∈ sup \{ M \}} {J}_{MODE}^{R , D} ( M \vert MB , QP ) \\ = {arg min}_{M ∈ sup \{ M \}} \{ {D}_{REC} ( M \vert MB , QP ) + {λ}_{MODE} {R}_{REC} ( M \vert MB , QP ) \}\end{matrix}$$

wherein the M* is the block mode; the brackets “{ }” represent options of the block mode; the MB is a selected block mode; the QP is an image quality parameter for the selected block mode; the D_{REC} is a difference between a current macroblock and a rebuilt macroblock after motion compensation, which represents quality; the λ_{MODE} is a Lagrange multiplier for the bit rate and the image quality; the R_{REC} represents an estimated value of the bit rate while the block mode is M. The motion estimation and mode decision unit 121 calculates the encoding parameter 120 according to these motion vector and the block mode equations.

Although an encoded video frame with high image quality and high compression ratio can be obtained by adopting this encoder, decoding ability of a decoder end is not considered. While the computation ability of the decoder end is insufficient, the decoder end cannot decode the video frame completely and successfully. Consequently, how to encode video frames properly so that the video frames can be decoded with little computation resource and time is a serious subject in this field.

### SUMMARY OF THE INVENTION

In order to solve the aforementioned problem, the subject invention proposes a method for motion estimation and mode decision, which takes decoding complexity into consideration so that encoding parameters may responds to a decoding complexity. The video frame encoding of an encoder can, hence, reduce the required computation of a decoder. Meanwhile, the distortion of an image is hardly observed by human eyes.

An object of this invention is to provide an encoder for adjusting decoding calculation according to a first encoding parameter. The first encoding parameter, the parameter used for an encoder of the prior art to encode, is generated based on a video frame. The encoder comprises a parameter generator, an adder and a complexity computation unit. The parameter generator initially generates an image quality parameter. The adder is configured to receive the first encoding parameter and the image quality parameter to generate a second encoding parameter. The complexity computation unit performs a complexity computation in response to the second encoding parameter to generate a third encoding parameter and an updating parameter. The parameter generator updates the image quality parameter in response to the updating parameter and the encoder encodes the video frame based on the third encoding parameter.

Another object of this invention is to provide a method for adjusting decoding calculation according to a first encoding parameter. The first encoding parameter, the parameter used for an encoder of the prior art to encode, is generated based on a video frame. The method comprises the following steps: generating an image quality parameter; generating a second encoding parameter according to the first encoding parameter and the image quality parameter; performing a complexity computation according to the second encoding parameter to generate a third encoding parameter and an updating parameter; updating the image quality parameter according to the updating parameter; and encoding the video frame based on the third encoding parameter.

Yet a further object of this invention is to provide a computer program product for storing a computer program to execute the aforementioned method.

For more obvious and easy understanding of said other purposes, features and advantages of the subject invention, the detailed descriptions are described in the following paragraphs accompanying the preferred embodiments and the appended drawings for people skilled in this field to well appreciate the features of the claimed invention.

### BRIEF DESCRIPTION OF THE DRAWINGS

FIG. 1 is an internal diagram of an encoder of the prior art;

FIG. 2 is a diagram of a first embodiment of the subject invention;

FIG. 3 is a flow chart of a second embodiment of the subject invention;

FIG. 4 is a flow chart of the second embodiment for generating an image quality parameter; and

FIG. 5 is a flow chart of the second embodiment for generating a third encoding parameter and an updating parameter.

### DESCRIPTION OF THE PREFERRED EMBODIMENT

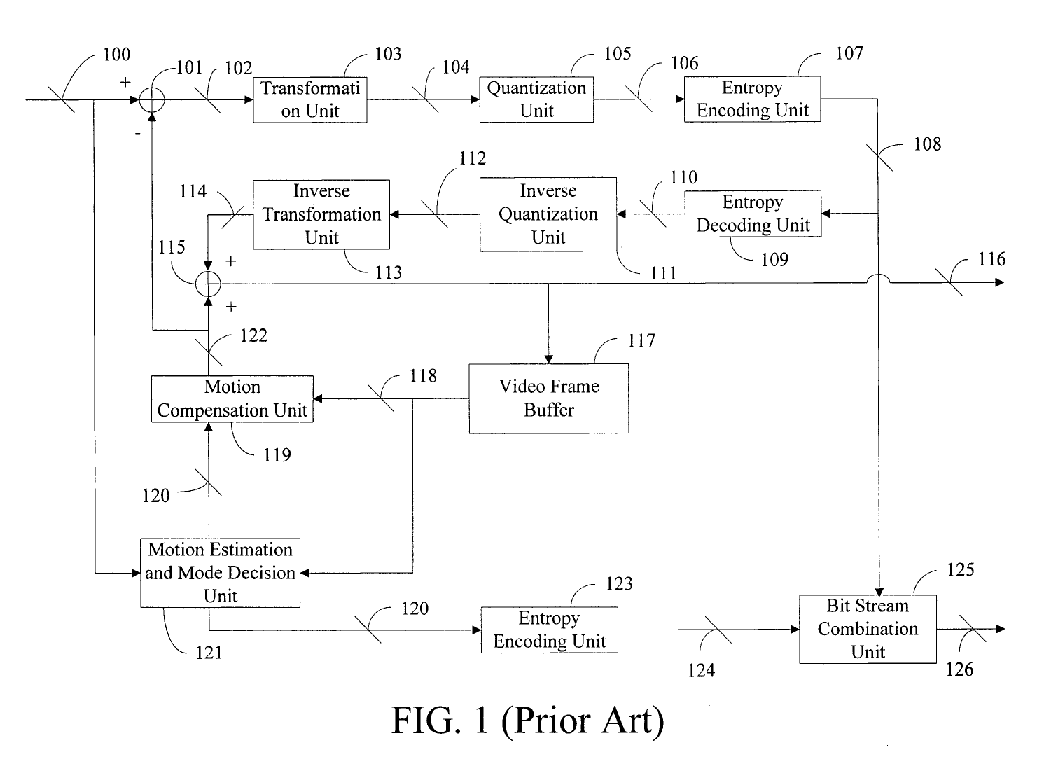

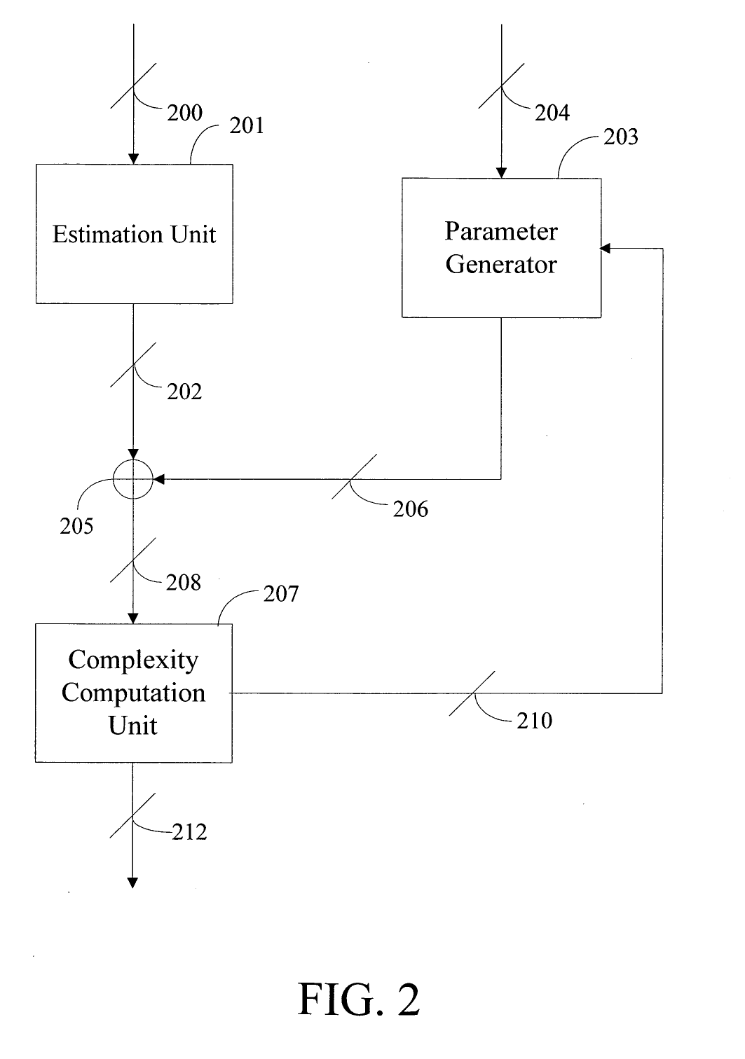

A first embodiment of the subject invention is an encoder for adjusting decoding calculation according to an encoding parameter of the prior art. The encoding parameter, i.e., the encoding parameter 120 as shown in FIG. 1 is generated based on a video frame. This embodiment can process sub-pixels so it can be used in the H.264 compression standard, MPEG2 compression standard, MPEG4 compression standard, and motion-compensation based video compression standard, etc. FIG. 2 shows a diagram of a motion estimation and mode decision unit (corresponding to the motion estimation and mode decision unit 121 in FIG. 1) of the encoder. As shown in FIG. 2, the motion estimation and mode decision unit comprises an estimation unit 201, a parameter generator 203, an adder 205 and a complexity computation unit 207. The estimation unit 201 is configured to receive a video frame 200 and calculate a first encoding parameter 202 according to the video frame 200, wherein the video frame 200 refers to the video frame 100 in FIG. 1 and the first encoding parameter 202 refers to the encoding parameter 120 as shown in FIG. 1.

The parameter generator 203 is configured to generate an image quality parameter 206 according to a predetermined value 204 and an updating parameter 210. The predetermined value 204 may be either pre-stored in the parameter generator 203 or inputted directly by a user as shown in FIG. 2. The predetermined value 204 is configured to decide a tolerable range of distortion for encoding the video frame 200. The basis of the tolerable range of distortion is the encoding that simply utilizes the encoding parameter 120 shown in FIG. 1. For example, the predetermined value 204 of 0.3 dB means that the acceptable distortion of the encoded image encoded by the encoder of the subject invention in view of the encoded image encoded by an encoder of the prior art is at most 0.3 dB. The updating parameter 210, generated by a complexity computation unit 207, is inputted to a counter within the parameter generator 203 to be compared with the predetermined value 204. The parameter generator 203 adjusts a memory access complexity in response to the predetermined value 204 and the updating parameter 210, and generates an image quality parameter 206 according to the memory access complexity. The memory access complexity is related to the decoding complexity of a decoder end. The higher the memory access complexity is, the higher the decoding complexity is required. More specifically, the parameter generator 203 derives the image quality parameter 206 according to the following equation:

$$\begin{matrix}{V}_{c}^{*} ( B , M ) = {arg min}_{V ∈ sup \{ V \}} {J}_{MODE}^{R , D , C} ( V \vert B , M ) \\ = {arg min}_{V ∈ sup \{ V \}} \{ {J}_{MOTION}^{R , D} ( V \vert B , M ) + {γ}_{MOTION} {C}_{MOTION} ( V \vert B , M ) \}\end{matrix}$$

wherein the V_{C}* denotes a selected motion vector; the brackets “{ }” represent options of the motion vector with a difference from the prior art in that the C_{MOTION} denotes a function for decoding complexity, which represents the cost of selected motion vector; γ_{MOTION} represents a Lagrange multiplier for the memory access complexity and is configured to adjust the cost of decoding complexity; J_{MOTION}^{R,D,C}(V) is a composed cost function involving a bit rate R, an image quality D and a decoder calculation complexity C. With the Lagrange operation, this embodiment takes the memory access complexity into consideration.

The adder 205 adds the first encoding parameter 202 and the image quality parameter 206 to generate a second encoding parameter 208.

The complexity computation unit 207 receives the second encoding parameter 208 and generates the updating parameter 210 and a third encoding parameter 212. The third encoding parameter 212 is outputted to the motion compensation unit 119 and the entropy encoding unit 123 shown in FIG. 1 to provide the required encoding parameters for encoding the video frame 200. The updating parameter 210 is fed back to the parameter generator 203 to update the image quality parameter 206. More specifically, the complexity computation unit 207 adjusts a decoding complexity according to the second encoding parameter 208, and generates the third encoding parameter 212 and the updating parameter 210 according to the decoding complexity. The decoding complexity is also related to the decoding complexity of the decoder end. The higher the decoding complexity is, the higher the decoding complexity of the decoder end is required. More particularly, the complexity computation unit 207 derives the updating parameter 210 and the third encoding parameter 212 according to the following equation:

$$\begin{matrix}{M}_{c}^{*} ( MB , QP ) = {arg min}_{M ∈ sup \{ M \}} {J}_{MODE}^{R , D , C} ( M \vert MB , QP ) \\ = {arg min}_{M ∈ sup \{ M \}} \{ {J}_{MODE}^{R , D} ( M \vert MB , QP ) + {γ}_{MODE} {C}_{MODE} ( M \vert MB ) \}\end{matrix}$$

wherein the M_{c}* is the selected block mode; the brackets “{ }” represent options of the block mode with a difference from the prior art in that the C_{MODE} denotes the cost of memory access complexity for each block mode; the γ_{MODE} represents a Lagrange multiplier for the decoding complexity and is configured to adjust the cost of the memory access complexity; J_{MODE}^{R,D,C}(V) is a composed cost function involving the bit rate R, the image quality D and the decoder calculation complexity C. With the Lagrange operation, the updating parameter 210 and the third encoding parameter 212 are generated.

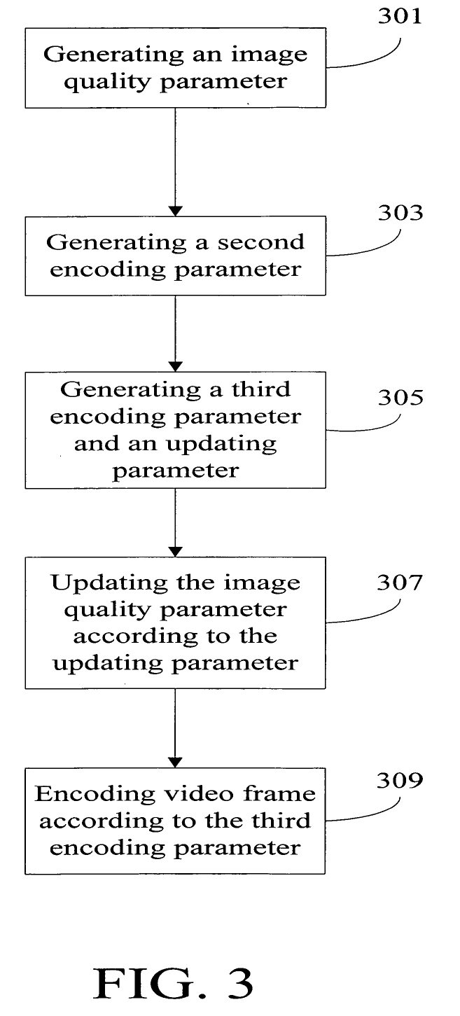

A second embodiment of the subject invention is a method for adjusting decoding calculation according to a first encoding parameter. The first encoding parameter, i.e., the encoding parameter 120 shown in FIG. 1 is generated based on a video frame. The method is shown in FIG. 3. In step 301, an image quality parameter is generated initially. Then step 303 is executed in which a second encoding parameter is generated according to the first encoding parameter and the image quality parameter. For example, the second encoding parameter is obtained by adding the first encoding parameter and the image quality parameter. Then step 305 is executed in which a third encoding parameter and an updating parameter are generated according to a complexity calculation in response to the second encoding parameter. Then step 307 is executed in which the image quality parameter is updated according to the updating parameter. Then step 309 is executed in which the video frame is encoded according to the third encoding parameter.

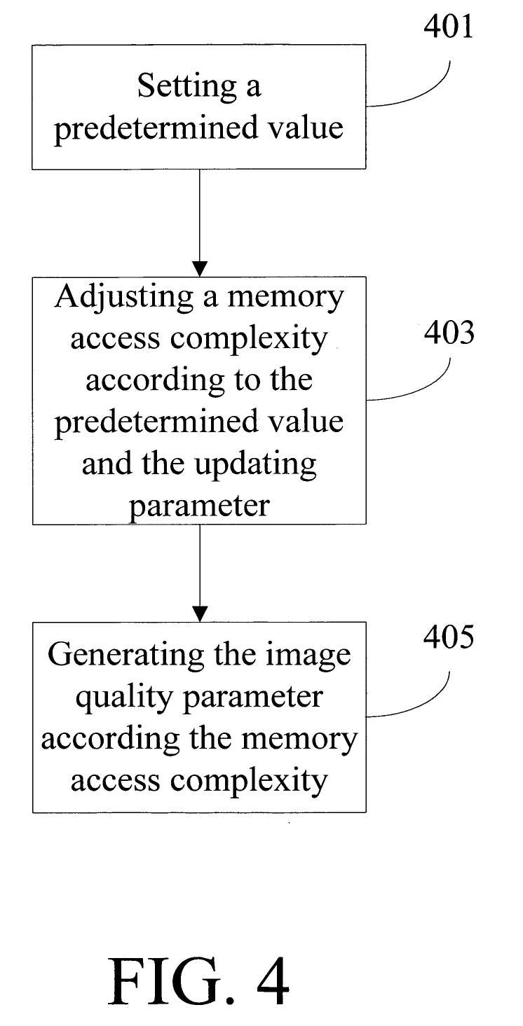

The image quality parameter in step 301 is generated according to a predetermined value, which is used to decide a tolerable range of distortion when encoding the video frame. The predetermined value is similar to that described in the first embodiment. As shown in FIG. 4, step 301 comprises the following steps. In step 401, a predetermined value is set. Then step 403 is executed in which a memory access complexity is adjusted according to the predetermined value and the updating parameter. Then step 405 is executed in which the image quality parameter is generated according to the memory access complexity.

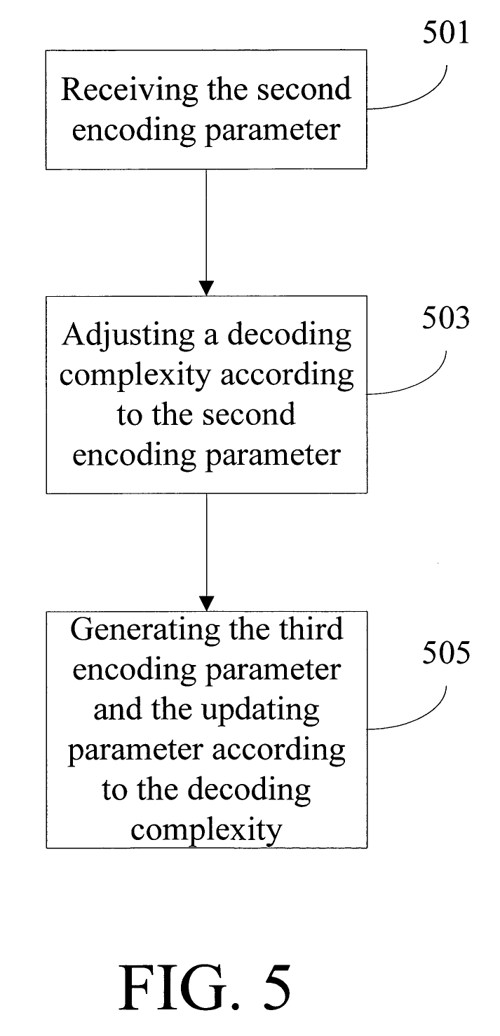

Referring to FIG. 5, step 305 comprises the following steps. In step 501, the second encoding parameter is received. Then step 503 is executed in which the decoding complexity is adjusted according to the second encoding parameter. Then step 505 is executed in which the third encoding parameter and the updating parameter are generated according to the decoding complexity.

The Lagrange operations used in the first embodiment may be used to derive the image quality parameter, the third encoding parameter and the updating parameter while executing step 301 and step 305.

Similarly, the second embodiment is capable of processing sub-pixels so that the second embodiment may be applied in the H.264 compression standard, the MPEG2 compression standard, the MPEG4 compression standard, and the motion-compensation based video compression standard.

The above-mentioned method may be performed by code in a computer program stored in a computer program product. The computer program product can be one of a floppy disk, a hard disk, an optical disc, a flash disk, a tape, a network accessible database or a storage medium with the same functionality which is known by those skilled in the art.

According to the above descriptions, the subject invention can solve the drawback of the encoders of the prior art. By way of considering the decoding complexity, the image quality can be substantially maintained and the distortion is imperceptible to human eyes. Meanwhile, the calculation cost of a decoder end is reduced and, therefore, decoding can be done completely and successfully. Furthermore, the subject invention saves power of the decoder end.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An encoder for adjusting decoding calculation according to a first encoding parameter, the first encoding parameter being generated based on a video frame, the encoder comprising:
a parameter generator for generating an image quality parameter;
an adder for receiving the first encoding parameter and the image quality parameter to generate a second encoding parameter; and
a complexity computation unit for performing a complexity computation in response to the second encoding parameter to generate a third encoding parameter and an updating parameter;
wherein the parameter generator updates the image quality parameter in response to the updating parameter and the encoder encodes the video frame based on the third encoding parameter.

2. The encoder as claimed in claim 1, wherein the parameter generator generates the image quality parameter in response to a predetermined value, and the predetermined value decides a distortion when the video frame is encoded.

3. The encoder as claimed in claim 2, wherein the parameter generator adjusts a memory access complexity in response to the predetermined value and the updating parameter, and generates the image quality parameter according to the memory access complexity.

4. The encoder as claimed in claim 1, wherein the adder adds the first encoding parameter and the image quality parameter.

5. The encoder as claimed in claim 1, wherein the complexity computation unit adjusts a decoding complexity according to the second encoding parameter, and generates the third encoding parameter and the updating parameter according to the decoding complexity.

6. The encoder as claimed in claim 1, wherein a compression standard of the encoder is one of an H.264 compression standard, an MPEG-2 compression standard, an MPEG-4 compression standard, and a motion-compensation based video compression standard.

7. A method for adjusting decoding calculation according to a first encoding parameter, the first encoding parameter being generated based on a video frame, the method comprising the following steps:
generating an image quality parameter;
generating a second encoding parameter according to the first encoding parameter and the image quality parameter;
performing a complexity computation according to the second encoding parameter to generate a third encoding parameter and an updating parameter;
updating the image quality parameter according to the updating parameter; and
encoding the video frame based on the third encoding parameter.

8. The method as claimed in claim 7, wherein the image quality parameter is generated according to a predetermined value and the predetermined value decides a distortion when the video frame is encoded.

9. The method as claimed in claim 8, wherein the step of generating an image quality parameter comprising the following steps:
adjusting a memory access complexity according to the predetermined value and the updating parameter; and
generating the image quality parameter according to the memory access complexity.

10. The method as claimed in claim 7, wherein the step of generating a second encoding parameter comprising the following step:
adding the first encoding parameter and the image quality parameter.

11. The method as claimed in claim 7, wherein the step of performing a complexity computation comprising the following steps:
adjusting a decoding complexity according to the second encoding parameter; and
generating the third encoding parameter and the updating parameter according to the decoding complexity.

12. The method as claimed in claim 7, wherein the method is applied for one of an H.264 compression standard, an MPEG-2 compression standard, an MPEG-4 compression standard, and a motion-compensation based video compression standard.

13. A computer program product for storing a computer program to execute a method for adjusting decoding calculation according to a first encoding parameter, the first encoding parameter being generated based on a video frame, the computer program comprising:
code for generating an image quality parameter;
code for generating a second encoding parameter according to the first encoding parameter and the image quality parameter;
code for performing a complexity computation according to the second encoding parameter to generate a third encoding parameter and an updating parameter;
code for updating the image quality parameter according to the updating parameter; and
code for encoding the video frame based on the third encoding parameter.

14. The computer program product as claimed in claim 13, wherein the image quality parameter is generated according to a predetermined value, and the predetermined value decides a distortion when the video frame is encoded.

15. The computer program product as claimed in claim 14, wherein the code for generating an image quality parameter comprising:
code for adjusting a memory access complexity according to the predetermined value and the updating parameter; and
code for generating the image quality parameter according to the memory access complexity.

16. The computer program product as claimed in claim 13, wherein the code for generating a second encoding parameter comprising:
code for adding the first encoding parameter and the image quality parameter.

17. The computer program product as claimed in claim 13, wherein the code for performing a complexity computation comprising:
code for adjusting a decoding complexity according to the second encoding parameter; and
code for generating the third encoding parameter and the updating parameter according to the decoding complexity.

18. The computer program product as claimed in claim 13, wherein the computer program is applied for one of an H.264 compression standard, an MPEG-2 compression standard, an MPEG-4 compression standard, and a motion-compensation based video compression standard.
